(19) United States
(12) Patent Application Publication
(10) Pub. No.: US 2007/0180807 A1
(43) Pub. Date: Aug. 9, 2007

(54) Machine for cutting and triturating grass and other vegetable products.

(76) Inventor: Fabrizio Castoldi, Milano (IT)

Correspondence Address: James V Costigan;Hedman & Costigan, 1185 Avenue of the Americas, New York, NY, 10036-2646, US

(21) Appl. No.: 10/565,337

(22) PCT Filed: Nov. 14, 2003
(86) PCT No.: PCT/IT03/00738

§ 371 Date: Dec. 22, 2006

(30) Foreign Application Priority Data
Jul. 25, 2003 (IT) MI2003A001537
Oct. 20, 2003 (IT) MI2003A002030

(51) Int. Cl. A01D 34/52

(52) U.S. Cl. 56/294

(57) ABSTRACT

A machine for cutting and triturating grass and other vegetable products, comprising a protection element (30), equipped with wheels, rollers or slides (35) and containing at least one pair of cutting assemblies (15, 16), wherein one cutting assembly (15) comprises blades of the lawn mower type or of the spoon-like type (21) and one cutting assembly (16) comprises shredding type blades (22), and a deflecting element (25, 125, 25′) being placed between the two cutting assemblies (15, 16) which causes the detachment of portions of the cut vegetable products from an inner wall of the protection element (30) and delivers them above the cutting assemblies (15, 16), said deflecting element (25, 125, 25′) protruding toward the inside of the protection element (30).

The present invention refers to a machine for cutting and triturating grass and other vegetable products.

In the field of machines for cutting and triturating grass and other vegetable products, several arrangements of blades are envisaged, for instance for cutting or for shredding, in function of the various parameters of interest.

In a first type of realization for cutting grass and other vegetable products horizontal blades rotating around vertical axis are envisaged, which intervene on the grass blades and other vegetables products and may also determine an assistance for the collection of the material cut in such manner. In fact, in a first typology of said machines the cut material can simply be expelled, falling back on the lawn.

In a second typology of machine for cutting and triturating grass and other vegetable products one or more blades are envisaged instead, with vertical axis, rotating in a horizontal plan, which more than just cutting the grass, direct it toward a collection bin, in collaboration, possibly, with means to suck out the cut material. Moreover, various configurations can be envisaged for the protection element of the blades, which concurs in directing and collecting the cut material.

Several typologies exist in the family with vertical axis in case of machines without collection, that is to say they leave the grass or other cut vegetable products on the ground:
with lateral discharge, wherein the grass or other cut vegetable products are laterally expelled and dispersed on the ground,
with discharge in the rear, wherein the grass or other cut vegetable products are discharged in the rear, generally along the whole width of the machine. One subtype of this category is represented by the “mulching” machines wherein the cut material is maintained, by means of special conveyors and bulkheads, in the cutting case and there is repeatedly cut by the cutting devices themselves until it falls on the ground in a finely minced way.

These machines work well when the grass or other vegetable products to be cut are not in a relevant quantity and above all are in dry condition. Otherwise jams can occur under the cutting plate, the treated material becomes compressed in small lumps and then is abruptly released leaving an unpleasant effect on the ground.

There is also a family of machines for cutting and triturating grass and other vegetable products wherein the blades are placed on shafts rotating around horizontal axis. The blades protrude from said shafts in radial directions, pulled toward the outside by the centrifugal force, and act on the grass blades or on the other vegetable products removing their upper part.

In this case lawn mowing or spoon-like type blades can be envisaged (characterized by the fact of having the cutting edge of the blade parallel to the rotation axis) which perform the cut, with a good quality of work, on the grass mantle. Subsequently, the cut material flows along the periphery of the case and is finally released on the ground. Also in this case, if the quantity to cut is high, the cut material remains on the ground in “long” grass blades with an unpleasant aesthetic effect and at the same time with a more difficult spontaneous degradation.

On the other hand, it is possible with shredding blades (characterized, for instance, by the fact of having the cutting edges of the blades placed radially or with a Y configuration) to work on high grass, other vegetable products etc. without having jams and excessive absorption of power. The cut material is grossly shredded and the cutting quality is rather low, therefore this solution is suitable for field work.

Objective of the present invention is to produce a machine for cutting and triturating grass and other vegetable products which, while allowing a uniform and good quality surface cut, is capable of operating in an optimal way also when the grass or other vegetable products are in great quantity and of considerable length.

A further objective is that of producing a machine for cutting and triturating grass and other vegetable products which is especially simple in its structure and easy to use.

A further objective is to produce a machine for cutting and triturating grass and other vegetable products which in all cases prevents jams while obtaining a suitable shredding of the cut material.

A further objective is to produce a machine suitable, for instance, to deal with field grass and even with other vegetable products such as bushes, vegetable residues of plants like runners and prunings as well as cut stems from cultivations, which remain in the ground after the crop: stubbles, stalks etc., avoiding jams while finely mincing the treated material.

These objectives, according to the present invention, are obtained producing a machine as described in claim 1.

Further characteristics of the invention are emphasized in the successive claims.

In the machine which is the object of this invention the cutting phase and the shredding phase of the grass or other vegetable products are clearly divided. Thus, it is possible with lawn mowing blades, spoon-like or club like for instance, to obtain a cut of optimal quality. Subsequently, in a peripheral area of the case, the shredding operation takes place, carried out by a second rotor, equipped with blades more suitable to the task.

Moreover, the shredding operation is easily adjustable in intensity by acting on a conveyor which directs more or less cut material toward the shredding rotor.

It is possible to adjust the operation of the machine to the various conditions of work (low or high, dry or wet grass, or other) always obtaining a good quality of cut and the maximum possible in shredding without ever having jams.

The characteristics and the benefits of a machine according to this invention will appear more evident from the following exemplifying and not limitative description, related to the attached schematic drawings, wherein:

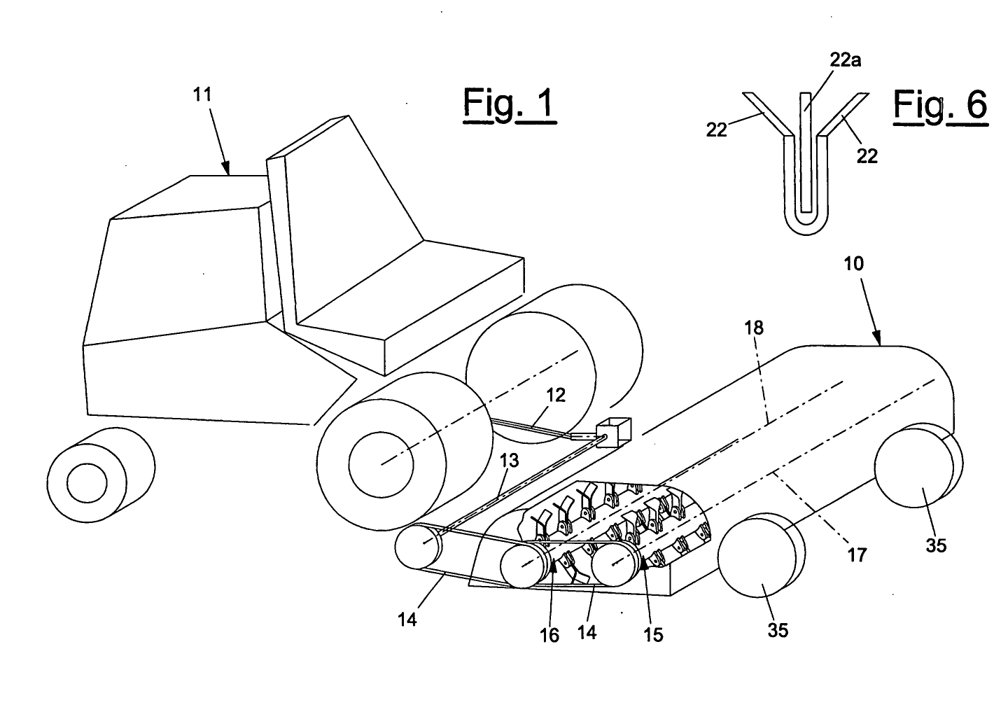

FIG. 1 is a perspective and schematic view of one machine according to this invention,

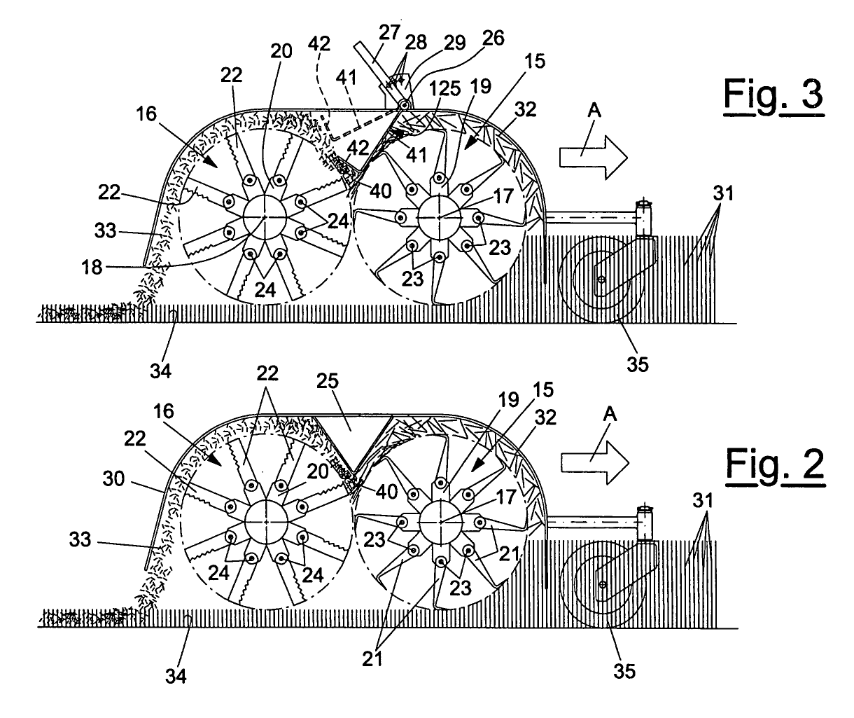

FIG. 2 is an enlarged section view of a first form of realization of the cutting assembly of the machine of this invention,

FIG. 3 is an enlarged section view of a second form of realization of the cutting assembly of the machine of FIG. 1, showing a deflecting element in two different operating positions,

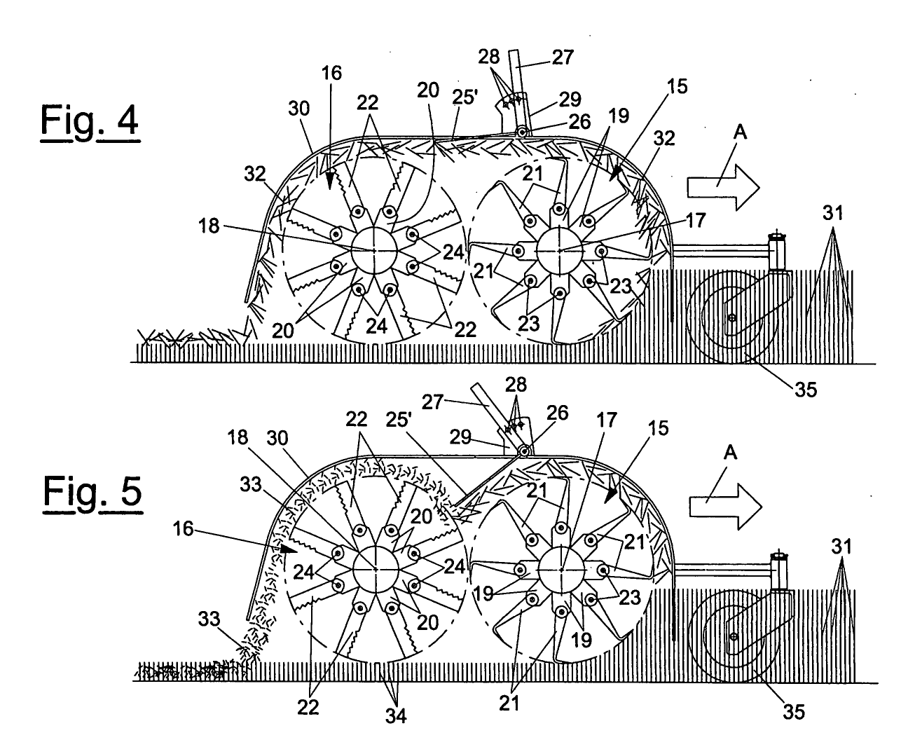

FIG. 4 is an enlarged section view of a further form of realization of the cutting assembly of the machine of FIG. 1 in a first operating position,

FIG. 5 is a view similar to that of FIG. 4 in a second operating position, and

FIG. 6 is a lateral schematic view of a blade assembly of the shredding type.

With reference to the figures, a machine according to this invention is shown, as a whole indicated with 10, which can operationally be set up by linking it to a motorized vehicle, outlined in 11. For instance, said vehicle 11 might be provided with a frontal power takeoff 12 which allows, by means of a transmission 13, to operate a single motion assembly of control belts 14, which act on a pair of rotating cutting assemblies 15 and 16, contained in a case or similar protection element 30.

The protection element 30, equipped at least with one pair of wheels 35 or rollers or slides, comprises in its interior said pair of cutting assemblies 15 and 16. The cutting assemblies 15, 16 are formed by a central shaft 17, 18, equipped with support extensions 19, 20 for their respective blades.

The support extensions 19 of the first cutting assembly 15 carry blades 21 of the lawn mowing or spoon-like type, oscillating around pivots 23.

The support extensions 20 of the second cutting assembly 16 carry blades 22 of the shredding or triturating type; for instance jagged, oscillating around the pivots 24. The blades of this second cutting assembly 16 may be two for each support extension and shaped in such a way as to diverge one from the other, as shown in FIGS. 1 and 6. Alternatively the said two blades 22 can be envisaged, situated as in the previous case, between which a third straight blade 22a is interposed, as shown in FIG. 6, which improves the cutting and shredding action.

According to the invention, between the two cutting assemblies 15 and 16 a deflecting element 25, 125 or 25′ is interposed, which is placed below the protection element 30, protrudes toward the inside of the protection element 30 and is at least partially peripherally connected with the blades 21 and 22 of both cutting assemblies 15, 16. In the example of FIG. 2 the deflecting element 25 is fixed below the protection element and shows a wedged shape, fitting in as a shape between the two cutting assemblies 15, 16. Such shape causes a forced deflection of the portions of cut grass or of other vegetable products just above the various cutting blades 21 and 22. Moreover, almost in correspondence with a tapered end of the deflecting element 25, a sort of chamber 40 for shredding the portions of grass is formed. The wedged shape of the deflecting element 25 creates a sort of stop to the portions of grass and other vegetable products and forces them to come into contact with the blades 21 and 22 of the cutting assemblies 15, 16 in order to be finely shredded.

Alternatively, as shown in FIG. 3, a deflecting element 125 can be envisaged, which is placed oscillating around a shaft 26 with respect to the outer protection element 30 and controllable by means of a lever 27. The lever 27 is joined to the deflecting element 125 and it is placed at right angles with respect to said deflecting element 125. Said lever 27 may be engaged in a series of positions indicated in 28 on an indicator plate 29. As previously said, the plate 29, the shaft 26, as well as the deflecting element 125, are placed on a protection element 30 which encloses the cutting assemblies 15 and 16 and which is part of the shredding machine for vegetable products 10.

In this form of realization, the deflecting element 125 shows a first portion 41 which is at least partially forced to peripherally connect with the first blades 21 of the cutting assembly 15. Moreover, from said first portion 41 protrudes a second portion 42, placed at right angles with respect to first portion 41, which is at least partially forced to peripherally connect with respect to second blades 22 of the other cutting assembly 16. Thus, when oscillating, the deflecting element 125 is forced to fit in as a wedge between the two cutting assemblies 15, 16. In this case also, we obtain a forced deflection of the portions of cut grass and other vegetable products to just above the various cutting blades 21 and 22, in other words toward that sort of chamber 40 for shredding the portions of cut grass, which can be detected between the deflecting element 125 and the two cutting assemblies 15, 16. FIG. 3 shows how said insertion of the deflecting element 125 is adjustable in such a way as to be able to vary its action on the portions of cut grass and other cut vegetable products to be shredded. FIGS. 4 and 5 show a further realization of the machine wherein a flat deflecting element 25′ can be moved at least from a position aligned with the protection element 30 to a position lowered down almost between the two cutting assemblies 15, 16 to deflect the portions of cut grass and other vegetable products 32.

The operation of such a machine turns out to be following.

When the grass of a meadow or other vegetable products must be cut, once the machine 10 is connected to the motorized vehicle 11 and the transmission 13 is connected to the power takeoff 12, the cut operation can be carried out.

In the first operational form of FIG. 2 it is clear, following what was said above, that the position of the deflecting element 25 fixed and wedged in between the cutting assemblies 15 and 16, dictates the path of the cut material. The blades of grass and of other vegetable products 31 come into contact with the lawn mowing or spoon-like blades 21 and the cut portions 32 of said materials are projected inside the protection element 30 and directed backwards with respect to the direction of forward movement of the machine. Thus, the cut portions 32, which come into contact with the wedge shaped deflecting element 25, are forced to go toward the chamber 40 where they are subjected to both the cutting assemblies 15, 16. Then, the shredding blades 22 of the second cutting assembly 16 carry the cut portions 32, in a more shredded and triturated form, from said chamber 40 again toward the external protection element 30, on which they slide, undergoing a further shredding treatment, and finally are unloaded on the ground above the cut zone 34.

Thus, a true homogenous and smooth cut is obtained, also when in presence of particularly long blades of grass 31, and, at the same time, the cut portions are finely triturated, shredded and released well distributed on the ground.

A similar operation can be referred to the second form of realization of FIG. 3, wherein the lever 27 is placed in such a position that the deflecting element 125 is placed lower in proximity of the cutting assemblies 15 and 16 (FIG. 3). Thus, the deflecting element 125 determines the forced path of the cut material, thanks also to the presence of the two portions 41 and 42 placed at right angles with each other. The cut portions 32 of the blades of grass and of other vegetable products 31 come into contact with the lawn mowing or spoon-like blades 21, which project them, because forced by portion .41 of the deflecting element 125, inside the chamber 40. There they are further treated by blades 22, thanks also to the presence of the further portion 42 of the deflecting element 125, before being dragged toward the protection element 30, backwards with respect to the forward direction of movement of the machine.

Said cut portions 32, which come into contact with the two portions at square angles 41 and 42 of the deflecting element 125, are forced inside the chamber 40 and are finely shredded by the nearly concurrent action of the two cutting assemblies 15 and 16. In an equivalent way to what was said above, the triturated portions 33, by means of the rotation of the second cutting assembly 16, are forwarded inside the protection element 30 and are released on the ground above the cut zone 34.

Thus, a homogenous and smooth cut is obtained, also when in presence of grass blades 31 particularly long, and at the same time the cut portions are finely triturated and released well distributed on the ground.

It is possible to notice, however, how the machine according to the invention may be used varying the distance of the deflecting element 125 from the protection element 30, by distancing it less at choice, as it is, for instance, shown with the dashed and dotted line in FIG. 3. In such a way the cut portions 32 of grass blades and of other vegetable products slide directly inside the protection element 30, being minimally affected by the action of the blades of the second cutting assembly 16.

In the further realization of the machine shown in FIGS. 4 and 5 the location of the lever 27 in such a position so that the deflecting element 25′ be lowered in proximity of the cutting assemblies 15 and 16 (FIG. 5), dictates the course followed by the grass and of the other cut vegetable products. Said cut portions 32 that come into contact with the deflecting element 25′ are forced by the same to become engaged on the second cutting assembly 16, whose shredding blades 22 shred the cut portions 32.

FIG. 4 shows instead how, maintaining the deflecting element 25′ in close contact with the protection element 30, the cut portions 32 of the grass blades and of other vegetable products slide directly inside the protection element 30, being minimally affected by the action of the blades of the second cutting assembly 16. Thus, the cut of the materials is obtained with the immediate release of the same materials on the ground and with the need of successive removal, if thought necessary.

FIG. 6 shows how the triturating blades 22 and 22a can be in a number greater than two in order to carry out an increased cutting and triturating action. Naturally, other numerous examples, not shown, of realization of said blades can exist. It is natural that the blades may be of various shapes and typologies in respect of the illustrated cutting assemblies. Moreover, the cutting assemblies, indicated as being in number of two, could be in a greater number to obtain a maximized triturating effect.

Moreover, the axis of the rotors, differently from what illustrated in the above figures, could be positioned with offsets at heights from ground different one from the other.

In a further type of feasible realization, always considering the direction of forward movement and of work of the machine, indicated with A, the cutting assemblies 15 and 16 can be placed differently. In fact, the cutting assembly with lawn mowing blades could be the second, while the first assembly could envisage shredding blades, with a general functionality of the machine different from the one above indicated.

Moreover, it can be envisaged that the machine be even of the manual type, in which the forward movement is due to the push of the operator and in which the cutting assemblies can be rotated by a motor.

The machine for cutting and triturating grass and other vegetable products according to this invention can be advantageously employed as a shredder to cut and to finely shred not only grass, but also of other vegetable products such as field grass, bushes, vegetable residues of plants as runners and prunings as well as cut stems from the cultivations that remain in the ground after the crop: stubbles, stalks, etc.

Therefore it has been seen that a machine for cutting and triturating grass and other vegetable products according to this invention achieves the objectives high-lighted above.

The machine for cutting and triturating grass and other vegetable products of this so conceived invention is susceptible to numerous modifications and versions, all included in the same inventive concept.

Moreover, in practice, the used materials as well as theirs dimensions and components could be whatever, according to the technical requirements.

1. A machine for cutting and triturating grass and other vegetable products, comprising a protection element (30), equipped with wheels, rollers or slides (35) and containing at least one pair of cutting assemblies (15, 16), wherein one cutting assembly (15) comprises blades of the lawn mower type or of the spoon-like type (21) and one cutting assembly (16) comprises shredding type blades (22), and a deflecting element (25, 125, 25′) being placed between the two cutting assemblies (15, 16) which causes the detachment of portions of the cut vegetable products from an inner wall of the protection element (30) and delivers them over the cutting assemblies (15, 16), said deflecting element (25, 125, 25′) protruding toward the inside of the protection element (30).

2. Machine according to claim 1, characterized by the fact of being a lawnmower.

3. Machine according to claims 1 or 2, characterized by the fact that said deflecting element (25, 125) is connected peripherally at least partially to the blades of both the two cutting assemblies (15, 16).

4. Machine according to claims 1 or 2, characterized by the fact that said deflecting element (25) is of the wedge type, is fixed to said protection element (30) and fits between said two cutting assemblies (15, 16).

5. Machine according to claim 4, characterized by the fact that said deflecting element (25) of wedge type together with said two cutting assemblies (15, 16) define a chamber (40) of treatment of grass and other cut vegetable products.

6. Machine according to claims 1 or 2, characterized by the said fact that said deflecting element (125, 25′) is movable in respect to said protection element (30).

7. Machine according to claim 6, characterized by the fact that said deflecting element (125) envisages one portion of extremity (42) placed at square angles in respect to a first pivoting portion (41) of said element.

8. Machine according to claim 6, characterized by the fact that said deflecting element (25′) can be moved at least from a position aligned with said protection element (30) to a lowered position, almost between said two cutting assemblies (15, 16), to deflect the portions of cut grass (32).

9. Machine according to claims 1 or 2, characterized by the fact that, in the direction of forward movement (A) of the lawnmower, said cutting assembly (15) equipped with lawn mowing or spoon-like type blades (21) is placed before said cutting assembly (16) equipped with shredding type blades (22).

10. Machine according to claims 1 or 2, characterized by the fact that both said two cutting assemblies (15, 16) are controlled by a single motion assembly (14).

11. Machine according to claim 10, characterized by the fact that said two cutting assemblies (15, 16) are controlled by a single motion assembly (14) connectable by means of a transmission (13) to a power takeoff (12) of a motorized vehicle (11).

12. Machine according to claims 1 or 2, characterized by the fact that both said lawn mowing or spoon-like type blades (21) and said shredding type blades (22) are constrained to support extensions (19, 20) which are bound to a central shaft (17, 18).

13. Machine according to claims 1 or 2, characterized by the fact that said deflecting element (125, 25′) is constrained, in an oscillating way, by means of a shaft (26) to said external protection element (30) and is controllable by means of a lever (27) joined to it.

14. Machine according to claim 1, characterized by the fact that it can be used as a shredder for cutting and finely shredding grass also of the field type or other vegetable products as bushes, vegetable residues of plants as runners and prunings as well as cut stems from the cultivations which remain in the ground after the crop, as stubbles, stalks or other.
